(19) United States
(12) Patent Application Publication
(10) Pub. No.: US 2008/0135719 A1
(43) Pub. Date: Jun. 12, 2008

(54) Baking cup with novelty base

(75) Inventors: Lynn Vendl, Woodridge, IL (US); Louis Henry, Scarsdale, NY (US)

Correspondence Address: PATENT GROUP;C/O DLA PIPER US LLP, 203 N. LASALLE ST., SUITE 1900, CHICAGO, IL, 60601, US

(73) Assignee: WILTON INDUSTRIES, INC.

(21) Appl. No.: 11/635,958

(22) Filed: Dec. 8, 2006

(51) Int. Cl. A47J 37/01; A21B 3/13; B29C 41/02

(52) U.S. Cl. 249/134; 249/117; 264/279.1

(57) ABSTRACT

A baking cup features a sidewall constructed of temperature resistant and flexible material. A bottom is formed near the bottom edge of the sidewall so that the sidewall and bottom define a cavity within which a foodstuff may be placed for baking. A base featuring a novelty shape supports the sidewall, bottom and cavity and includes a rigid core covered by a skin layer. The skin layer is constructed of the same flexible material as, and integrally formed with, the sidewall and bottom.

### FIELD OF THE INVENTION

The present invention relates generally to baking and, more particularly, to baking cup with a novelty base to facilitate baking cupcakes and other food items and serving same.

### BACKGROUND OF THE INVENTION

The traditional baking pan for cupcakes is a tray with a number of cupcake depressions. The cupcake batter is poured into the depressions and the pan is placed in an oven for baking. A problem associated with using such a pan, however, is the sticking of the cupcakes to the depressions of the pan. This makes it very difficult to remove the cupcakes from the pan and very often results in breaking up of the cupcakes or the tearing away of the outer portions of the cupcakes.

These problems are alleviated by placing paper baking cups in the depressions of the tray and pouring batter into the paper cups. After baking, the paper cup and cupcake are removed from the pan as a unit. The paper cups feature sidewalls that are corrugated so that removal of the cupcakes from the paper cups is facilitated.

While paper baking cups may only be used a single time an then are discarded, baking cups may alternatively be made of high temperature, reusable materials such as silicone.

Cupcakes are often served at parties or in other situations where it is desirable to provide a decorative presentation of food items. As a result, cupcakes are often placed on decorative cupcake trays or stands. A need exists, however, for a baking cup that permits an individual cupcake to be presented in a decorative fashion. Furthermore, it is desirable for such a baking cup to be used without additional serving preparation steps, such as placing the cupcake on a stand or adding decorative attachments.

Furthermore, it is desirable to provide a support for a cupcake that allows the cupcake to cool rapidly after removal from the oven. More specifically, a base that elevates a baking cup over a surface so that air may flow under the bottom of the baking cup cools the cupcake, or other food item within the baking cup, more rapidly. It would be beneficial for such a base to be attached to the baking cup to facilitate handling. This requires that the base be capable of withstanding the high temperature associated with baking.

It is also desirable for the base to be integrally formed with the remainder of the baking cup so that no adhesives are necessary for attaching the base. Such an approach simplifies manufacturing and increases the durability of the baking cup as there is no adhesive or joint to fail.

### BRIEF DESCRIPTION OF THE DRAWINGS

FIG. 1 is a perspective view of an embodiment of the baking cup of the present invention;

FIG. 2 is a side elevational view of the baking cup of FIG. 1;

FIG. 3 is a cross sectional view of the baking cup of FIGS. 1 and 2 taken along line 3-3 of FIG. 2;

FIG. 4 is a cross sectional view of the baking cup of FIGS. 1-3 taken along line 4-4 of FIG. 3; and

FIG. 5 is a cross sectional view of the baking cup of FIGS. 1-4 taken along line 5-5 of FIG. 4.

### DETAILED DESCRIPTION

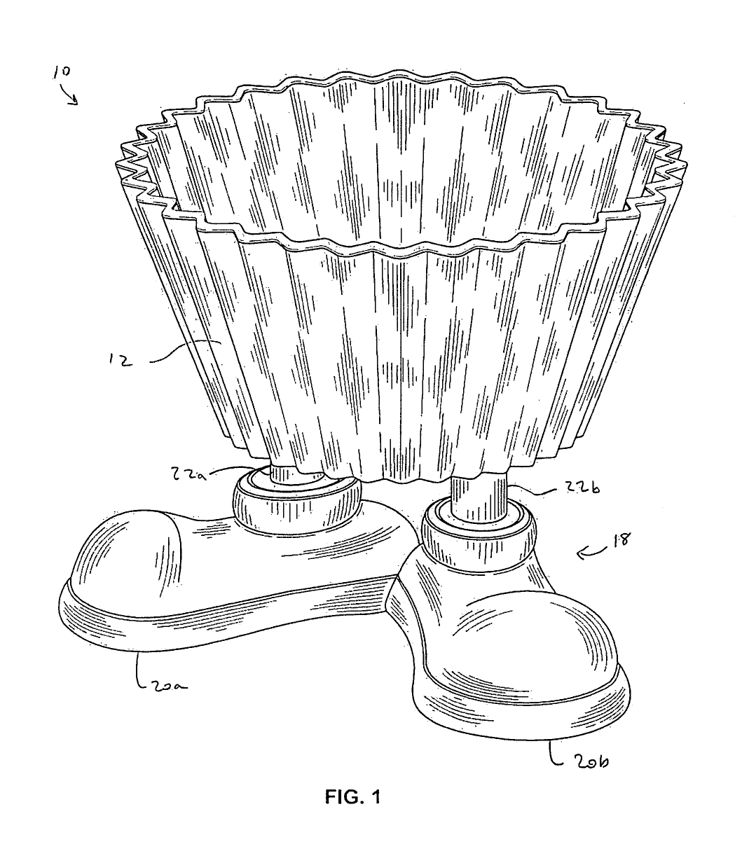

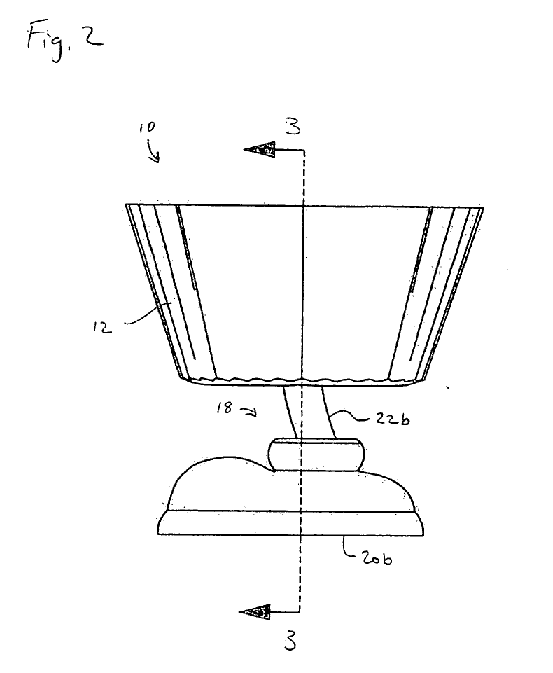

An embodiment of the baking cup of the present invention is indicated in general at 10 in FIGS. 1 and 2. While the baking cup 10 of FIGS. 1 and 2 is for baking cupcakes, it is to be understood that the present invention could be used for baking other food items.

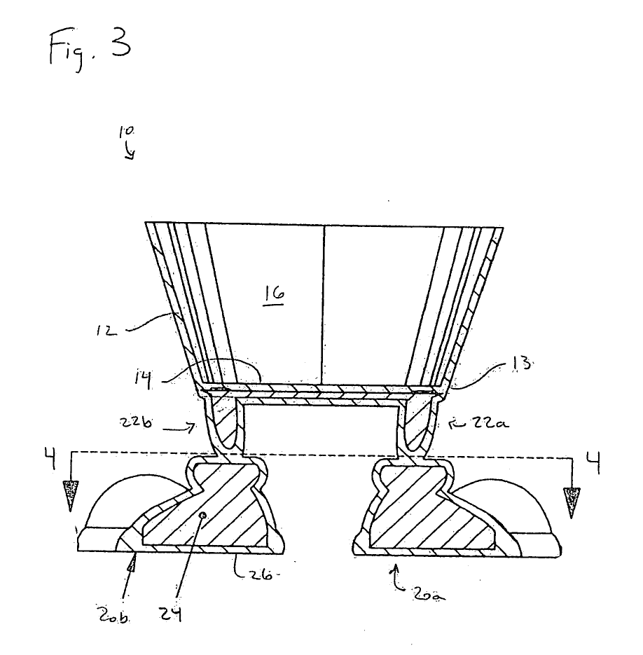

As illustrated in FIGS. 1 and 2, the baking cup 10 features a corrugated sidewall 12 which is preferably constructed of a flexible and reusable material that is able to withstand high temperatures, such as silicone. As illustrated in FIG. 3, corrugated sidewall 12 has a bottom edge portion 13 that circumscribes bottom 14. As a result, the corrugated sidewall 12 and bottom 14 define a cavity 16 into which cupcake batter or other foodstuff may be poured for baking. Corrugated sidewall 12 allows the resulting baked cupcake, or other food item, to be easily removed from the baking cup.

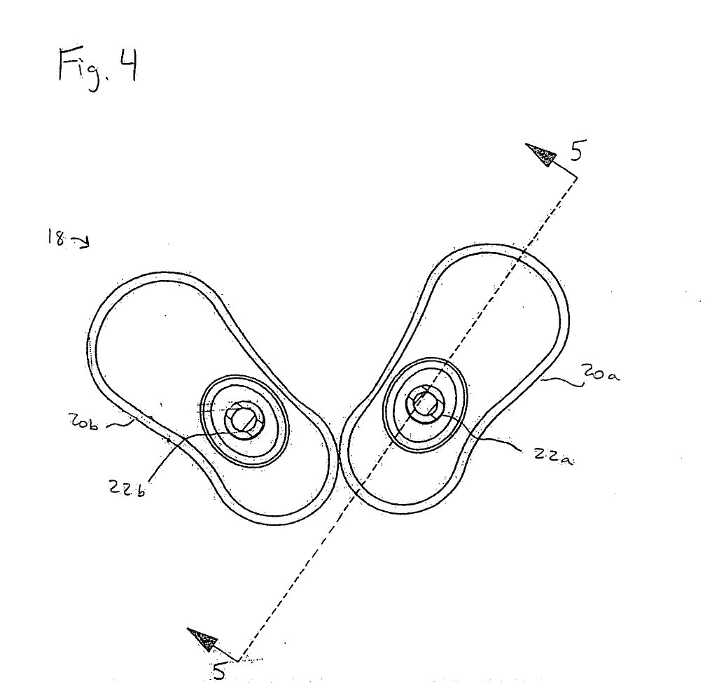

As illustrated in FIGS. 1, 2 and 4, the corrugated sidewall 12 and bottom of the baking cup are supported by a base, indicated in general at 18, featuring foot portions 20a and 20b and leg portions 22a and 22b. The base elevates the bottom 14 (FIG. 3) of the baking cup off of a surface and thus permits air to flow underneath the cavity 16 so that the cupcake or other baked item therein may more rapidly cool after baking.

While corrugated sidewall 12 of the baking cup should be flexible, to allow for easy removal of baked items from the baking cup, foot portions 20a and 20b and leg portions 22a and 22b should be rigid enough to support the corrugated sidewall 12, bottom 14 and the contents of cavity 16. It is also desirable to integrally form the base with the remaining portion of the baking cup to simplify manufacturing and so that there are no joints or no adhesives to fail. This particularly adds durability to the product since it is exposed to the high temperatures of baking.

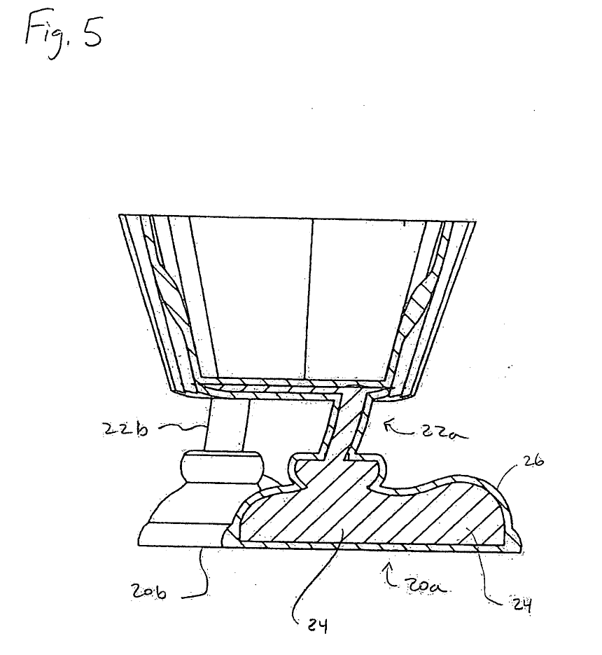

With reference to FIGS. 3 and 5, the foot and leg portions 20a, 20b, 22a and 22b of the base feature a core, illustrated at 24. The core 24 is constructed of a hard, heat resistant plastic, preferably nylon. As illustrated in FIGS. 3 and 5, the core 24 is covered by a skin layer 26 of material that, like corrugated sidewall 12 and bottom 14, is preferably silicone. As a result, the skin layer 26 of material covering the foot and leg portions may be integrally formed or molded with corrugated sidewall 12 and bottom 14. Furthermore, the silicone is molded over the nylon core. The baking cup thus features both ease of manufacturing and durability.

The base 18 illustrated features a decorative novelty appearance with a pair of legs and feet supporting the cupcake or other baked good. The construction described above, however, permits baking cups to be manufactured with bases having a variety of alternative novelty shapes. Furthermore, while the baking cup of FIGS. 1-5 is of the typical inverted frusto-conical shape, having a generally round bottom, baking cups of alternative shapes may be constructed in accordance with the present invention. These include, but are not limited to, baking cups having square, diamond, triangular, heart-shaped and football-shaped bottoms.

While embodiments of the invention have been shown and described, it will be apparent to those skilled in the art that changes and modifications may be made therein without departing from the spirit of the invention.

What is claimed is:

1. A baking cup comprising:
a) a sidewall constructed of temperature resistant and flexible material;
b) a bottom formed near the bottom edge of the sidewall so that said sidewall and bottom define a cavity within which a foodstuff may be placed for baking; and
c) a base supporting said sidewall, bottom and cavity, said base including a rigid core covered by a skin layer, said skin layer constructed of the same flexible material as, and integrally formed with, the sidewall and bottom.

2. The baking cup of claim 1 wherein the sidewall is corrugated.

3. The baking cup of claim 1 wherein the sidewall, bottom and skin layer are made from silicone.

4. The baking cup of claim 3 wherein the rigid core is constructed from nylon.

5. The baking cup of claim 4 wherein the silicone skin layer is molded over the nylon rigid core.

6. The baking cup of claim 1 wherein the rigid core is constructed from nylon.

7. The baking cup of claim 1 wherein the base includes foot portions.

8. The baking cup of claim 7 wherein the base includes leg portions positioned between the foot portions and the bottom.

9. The baking cup of claim 1 wherein the skin layer is molded over the rigid core.

10. The baking cup of claim 1 wherein the bottom is generally round.

11. The baking cup of claim 1 wherein the sidewalls and bottom form an inverted frusto-conical shape.

12. A method of manufacturing a baking cup featuring a novelty base including the steps of:
a) providing a core of rigid material; and
b) forming a sidewall, bottom and base out of flexible and temperature resistant material, where the base includes a skin layer that covers the rigid core.

13. The baking cup of claim 12 wherein the sidewall is corrugated.

14. The baking cup of claim 12 wherein the sidewall, bottom and skin layer are made from silicone.

15. The baking cup of claim 14 wherein the rigid core material is nylon.

16. The baking cup of claim 15 wherein the silicone skin layer is molded over the nylon rigid core.

17. The baking cup of claim 12 wherein the rigid core material is nylon.

18. The baking cup of claim 12 wherein the base includes foot portions.

19. The baking cup of claim 18 wherein the base includes leg portions positioned between the bottom and the foot portions.

20. The baking cup of claim 12 wherein the skin layer is molded over the rigid core.
